(19) United States
(12) Patent Application Publication
(10) Pub. No.: US 2005/0157207 A1
(43) Pub. Date: Jul. 21, 2005

(54) Automatic selection of illumination source for hybrid digital cameras

(76) Inventors: James S. Voss, Fort Collins, CO (US); William Robert Haas, Fort Collins, CO (US); Kirk Steven Tecu, Greeley, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/762,870

(22) Filed: Jan. 21, 2004

(51) Int. Cl. H04N 5/222; G03B 9/70

(52) U.S. Cl. 348/371; 396/166; 348/220.1

(57) ABSTRACT

A digital camera is built having a still mode and a video mode. The camera is configured to control two different light sources. When the camera is in still mode, it is configured to fire a strobe during capture of the image. When the camera is in video mode, it is configured to turn on a continuous light source during capture of the video. These two different light sources may be combined into a single unit or may exist as separate devices. In video mode, a partial depress of the shutter control may turn on the continuous light source prior to exposure, allowing the light source to stabilize before video capture begins.

### CROSS-REFERENCE TO RELATED APPLICATION

This application is related to application Ser. No.______ entitled, “Combination LED and Strobe Lighting Device,” filed on or about the same date as the present application, and hereby incorporated herein by reference. Application Ser. No.______ discloses and claims a device including both a strobe tube and at least one LED configured to switch between the strobe and the LED based on a mode of operation.

### FIELD OF THE INVENTION

The present invention relates generally to the field of photography and more specifically to the field of lighting of photographic subjects for still and video imaging.

### BACKGROUND OF THE INVENTION

Many modern digital cameras include both a still photography mode and a video mode. In the video mode, short moving video clips are captured by the digital camera. These video clips may range in length from a few seconds to several minutes. The lighting requirements for these two modes of operation are significantly different. In digital still cameras a very bright flash for scene illumination is often desired so that high shutter speeds can be used to stop and freeze any motion in the scene being captured. In video mode, a more uniform constant light source is desired.

### SUMMARY OF THE INVENTION

A digital camera is built having a still mode and a video mode. The camera is configured to control two different light sources. When the camera is in still mode, it is configured to fire a strobe during capture of the image. When the camera is in video mode, it is configured to turn on a continuous light source during capture of the video. These two different light sources may be combined into a single unit or may exist as separate devices. In video mode, a partial depress of the shutter control may turn on the continuous light source prior to exposure, allowing the light source to stabilize before video capture begins.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 is front view of an example embodiment of a digital camera including a lighting control output according to the present invention.

FIG. 2 is front view of an example embodiment of a digital camera including a lighting control output and attached to an off-camera flash according to the present invention.

FIG. 3 is a cross-sectional view of a lighting device including two LEDs, a strobe, and a single reflector.

FIG. 4 is a cross-sectional view of a lighting device including one LED, a strobe, and two reflectors.

### DETAILED DESCRIPTION

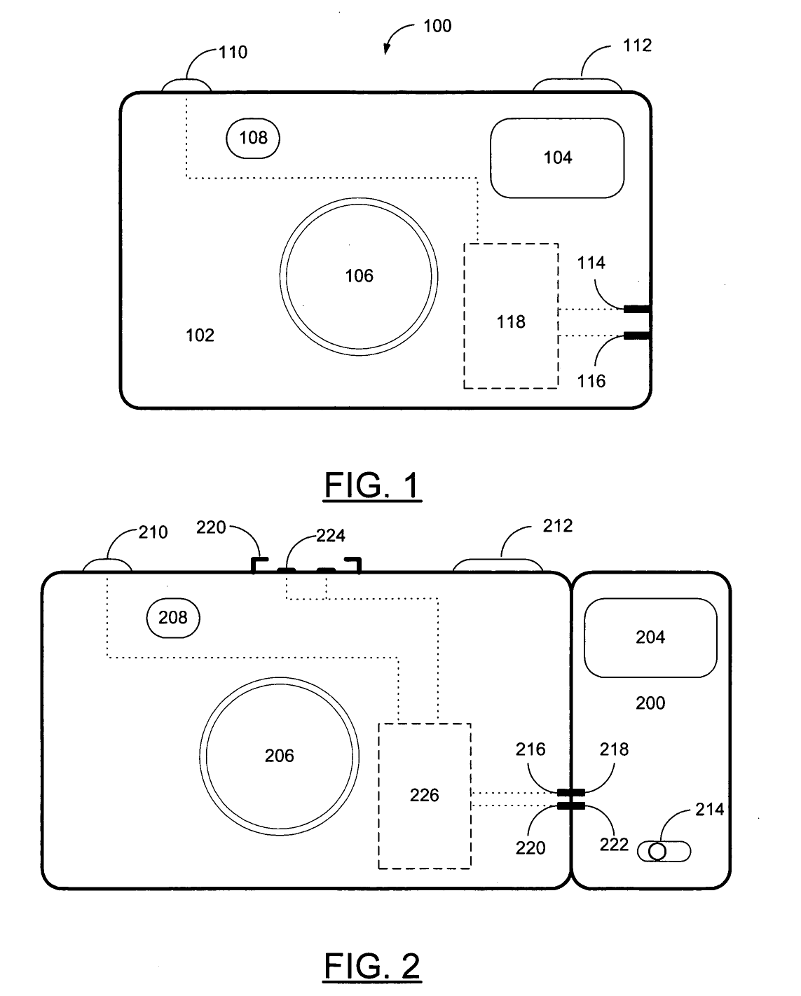

FIG. 1 is front view of an example embodiment of a digital camera including a lighting control output according to the present invention. An example embodiment of a camera 100 constructed according to the present invention may include a camera body 102, a lens 106, a flash 104, an external viewfinder window 108, a shutter release 110, and a control 112. In an example embodiment of the present invention, the control 112 may be used to select a mode of the digital camera. These modes may include a still photo mode and a video mode. This example embodiment of the present invention also includes two lighting control outputs. A first output 114 outputs a first signal that is used to fire an off-camera flash when the camera is in still mode. A second output 116 outputs a second signal that is used to activate an off-camera continuous light when the camera is in video mode. In some example embodiments of the present invention, when the shutter release 110 is partially depressed, the camera is configured to send a signal to the second output 116 activating the continuous light before the shutter release 110 is fully depressed, starting the video capture. This allows the continuous light some time to turn on and stabilize before video capture begins. As with all digital cameras, this example embodiment of the present invention includes a circuit 118 electrically connected to the shutter release 110, configured to generate the first and second signals, and electrically connected to the first output 114 and the second output 116. This circuit 118 includes a means for detecting when the shutter release 110 is depressed. In some example embodiments of the present invention, the circuit 118 may also be configured to detect when the shutter release 110 is partially depressed. Note that the digital camera 100 in this example embodiment of the present invention includes a built-in flash 104 or other means for creating a flash of light. In some embodiments of the present invention, this built-in flash 104 may be used in still mode instead of triggering an external flash. However, some embodiments may allow the user to select between firing the built-in flash 104 and triggering an external flash through the first output 114.

FIG. 2 is front view of an example embodiment of a digital camera attached to a lighting device including a LED and a strobe according to the present invention. Similar to the digital camera of FIG. 1, this example embodiment of a camera includes a camera body 202, a lens 206, an external viewfinder window 208, a shutter release 210, a control 212, a hot shoe 220 including hot shoe electrical contacts 224. As with all digital cameras, this example embodiment of the present invention includes a circuit 226 electrically connected to the shutter release 210, configured to generate the first and second signals, and electrically connected to the first output 216 and the second output 220, and to the hot shoe electrical contacts 224. This circuit 226 includes a means for detecting when the shutter release 210 is depressed. In some example embodiments of the present invention, the circuit 226 may also be configured to detect when the shutter release 210 is partially depressed. In an example embodiment of the present invention, the control 212 may be used to select a mode of the digital camera. These modes may include a still photo mode and a video mode. This example embodiment also includes dedicated lighting control outputs separate from the hot shoe electrical contacts 224. A first output 216 outputs a first signal that is used to fire an off-camera flash when the camera is in still mode. A second output 220 outputs a second signal that is used to activate an off-camera continuous light when the camera is in video mode. Both the first and second outputs 216, 220, and the hot shoe electrical contacts 224 may be used to control a mode of one or more lighting devices 200. Note that unlike the camera of FIG. 1, this example embodiment of the present invention does not include a built-in flash. Thus, when a flash is required in still mode, an external flash must be triggered by the first output 216 or the hot shoe electrical contacts 224. This example embodiment of the present invention includes a lighting device 200 with a combined LED and strobe 204, a first input 218, a second input 222, and a switch 214. The first input 218, second input 222, and the switch 214 may be used to select a mode of the flash. In a still mode, the strobe of the flash is activated when triggered by the camera. This triggering may occur through the first control input 218. In a video mode, the LED is activated when triggered by the camera. This triggering may occur through the second input 222. In an example embodiment of the present invention, the switch 214 may allow a user to override the mode signal communicated from the camera through the outputs 216, 220 into the inputs 218, 222 of the lighting device 200. Those of skill in the art will also recognize that a hot shoe is not the only possible means for non-permanently mechanically coupling a lighting device to the digital camera. Some lighting devices attach to a camera through the tripod mount and electrically connect to a camera through any of a wide variety of electrical cords, such as PC cords. In such example embodiments of the present invention the first and second outputs (means for outputting first and second signals) may be present in a wide variety of configurations within the scope of the present invention.

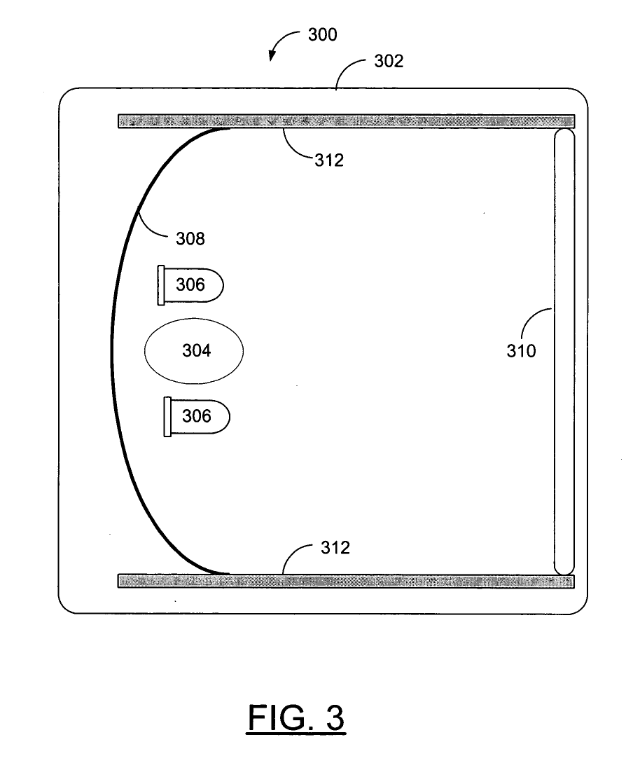

FIG. 3 is a cross-sectional view of a lighting device including two LEDs, a strobe, and a single reflector. This example lighting device may be used with digital cameras build according to the present invention. This example lighting device includes both a strobe for taking flash still photos, and a pair of LEDs that may be illuminated as a continuous light source for shooting video. In this example embodiment a lighting device 300 is built including a body 302 with supports 312 for a reflector 308 and a lens 310. In this lighting device two LEDs 306 share the common reflector 308 with a strobe tube 304.

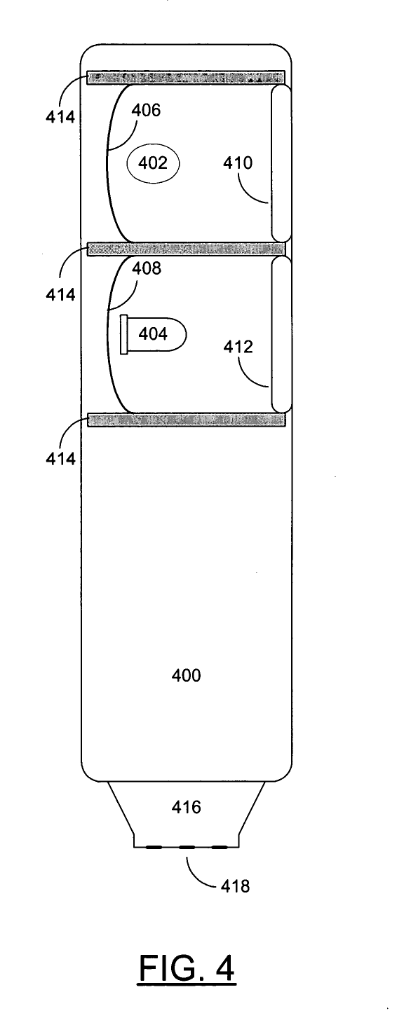

FIG. 4 is a cross-sectional view of a lighting device including one LED, a strobe, and two reflectors. This example lighting device may be used with digital cameras build according to the present invention. This example lighting device includes both a strobe for taking flash still photos, and an LED that may be illuminated as a continuous light source for shooting video. In this example embodiment a lighting device 400 is built including a body with supports 414 configured to mechanically affix a first reflector 406, a first lens 410, a second reflector 408, and a second lens 412. A strobe tube 402 is configured to use the first reflector 406 and the first lens 410, while a LED 404 is configured to use the second reflector 408 and the second lens 412. This lighting device includes a hot shoe foot 416 including flash input connections 418 configured to electrically couple to the hot shoe of the camera shown in FIG. 2. When used with the digital camera shown in FIG. 2, the camera and lighting device may be electrically coupled through the hot shoe electrical contacts 222 and the corresponding flash input connections 418 on the hot shoe foot 416. When the digital camera is in still mode, it signals the lighting device through the hot shoe electrical contacts 222 to fire the strobe tube 402 during exposure. When the digital camera is in video mode, it signals the lighting device through the hot shoe electrical contacts 222 to activate the LED 404 continuously during the video capture.

The foregoing description of the present invention has been presented for purposes of illustration and description. It is not intended to be exhaustive or to limit the invention to the precise form disclosed, and other modifications and variations may be possible in light of the above teachings. The embodiments were chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

1. A digital camera having a still mode and a video mode, comprising:
a body;
a mode control mechanically coupled to said body, configured to switch said digital camera between said still mode and said video mode;
a shutter control mechanically coupled to said body;
a first output, configured to output a first signal when said digital camera is in said still mode and said shutter control is depressed; and
a second output, configured to output a second signal when said digital camera is in video mode and said shutter control is depressed.

2. The digital camera recited in claim 1, further comprising:
a hot shoe mechanically coupled to said body, configured to non-permanently mechanically couple a lighting device to said digital camera.

3. The digital camera recited in claim 2, further comprising:
a hot shoe electrical contacts mechanically coupled to said body, including said first output and said second output.

4. The digital camera recited in claim 1, wherein:
said first signal fires a strobe.

5. The digital camera recited in claim 4, wherein:
said strobe is built-in to said digital camera.

6. The digital camera recited in claim 1, wherein:
said second signal activates a continuous light source.

7. The digital camera recited in claim 6, wherein:
said second signal is activated when said shutter control is partially depressed, and said second signal is deactivated when said shutter control is released.

8. The digital camera recited in claim 6, wherein:
said continuous light source comprises at least one LED.

9. A digital camera having a still mode and a video mode, comprising:
means for switching said digital camera between said still mode and said video mode;
means for detecting the depression of a shutter control;
means for creating a first signal when said digital camera is in said still mode and said shutter control is depressed;
means for creating a second signal when said digital camera is in video mode and said shutter control is depressed;
means for outputting the first signal; and
means for outputting the second signal.

10. The digital camera recited in claim 9, further comprising:
means for non-permanently mechanically coupling a lighting device to said digital camera.

11. The digital camera recited in claim 10, further comprising:
means for contacting said first output and said second output within said means for non-permanently mechanically coupling a lighting device to said digital camera.

12. The digital camera recited in claim 9, wherein:
said first signal fires a strobe.

13. The digital camera recited in claim 12, further comprising:
means for creating a flash of light.

14. The digital camera recited in claim 9, wherein:
said second signal activates a continuous light source.

15. The digital camera recited in claim 14, wherein:
said second signal is activated when a shutter control is partially depressed, and said second signal is deactivated when a shutter control is released.

16. The digital camera recited in claim 14, wherein:
said continuous light source comprises at least one LED.

17. The digital camera recited in claim 9, wherein:
said means for detecting the depression of a shutter control also includes means for detecting the partial depression of the shutter control.
